(19) United States
(12) Patent Application Publication
(10) Pub. No.: US 2003/0155698 A1
(43) Pub. Date: Aug. 21, 2003

(54) Resilient joint for vehicle suspension

(76) Inventors: Serge Lefebvre, Clermont-Ferrand (FR); Michel Gautheron, Nevers (FR)

Correspondence Address: BAKER BOTTS L.L.P., 44TH FLOOR, 30 ROCKEFELLER PLAZA, NEW YORK, NY, 10112-0228, US

(21) Appl. No.: 10/109,404

(22) Filed: Mar. 28, 2002

Related U.S. Application Data
(63) Continuation of application No. PCT/FR01/02468, filed on Jun. 27, 2001.

(30) Foreign Application Priority Data
Jul. 28, 2000 (FR) 00/09906

(51) Int. Cl. B60G 11/18; F16F 1/48; F16F 1/44

(52) U.S. Cl. 267/279; 267/273; 267/293

(57) ABSTRACT

The disclosure concerns an elastic articulation designed to be linked to a vehicle body suspension arm and capable of operating in torsion and of carrying a substantial part of the body weight, comprising an inner reinforcement 8, an outer reinforcement 9 enclosing the inner reinforcement, and an elastomeric sleeve 7, arranged between the inner and outer reinforcements and whereof the inner and outer peripheral surfaces are linked without any possibility of sliding to said inner and outer reinforcements. The disclosure is further characterized in that the outer reinforcement 9 is configured so as to be able to be fixed directly to the body of a vehicle, without any intermediate rigid support part.

### CROSS REFERENCE TO RELATED APPLICATIONS

This application is a continuation of international application Serial No. PCT/FR01/02468, filed Jul. 27, 2001 and published as WO 02/09960 in French, which further claims priority to French application Serial No. FR 00/09906 filed Jul. 28, 2000.

### INTRODUCTION

The present invention concerns, in general, resilient joints and, in particular, a resilient joint intended to connect a suspension arm to a vehicle body and capable of working on torsion and of carrying a substantial part of the weight of the body.

### BACKGROUND OF THE INVENTION

In the present text, “resilient joint capable of working on torsion and of carrying a substantial part of the weight of the vehicle body” is understood to be an elastic articulation having a torsional rigidity around the axis of the joint, so that it is capable of supporting a substantial part of the weight of the vehicle body without it being necessary to attach strong metal springs or other elastic elements to the suspension arms of the wheels of the vehicle in order to support the weight of the body. To clarify matters, automobile manufacturers usually require a vertical rigidity at each wheel which varies according to the passenger vehicle within a range in the order of 8 to 20 N/mm. In order to achieve that result, the resilient joints proposed have, depending on the lengths of the wheel suspension arms, a torsional rigidity ranging between 10 and 40 m.N/degree. By comparison, a standard resilient joint, put in the same place on the same vehicle and designed to work essentially on compression, which does not carry the weight of the vehicle body, generally has a torsional rigidity of less than 1 m.N/degree.

The present invention is applicable notably, but not exclusively, to a resilient joint with variable radial rigidity, the radial rigidity having a minimal value along a first reference axis of a system of three reference axes, a second reference axis of which is merged with the axis of rotation of the resilient joint. “Radial rigidity” is understood here to mean the rigidity of the joint in any direction perpendicular to the axis of rotation of the joint. Usually, in the case of a resilient joint for vehicle suspension, the “first reference axis” mentioned above is oriented perpendicular or roughly perpendicular to a horizontal plane of reference linked to the body of the vehicle. “Horizontal plane of reference linked to the body” is understood here to mean a plane which is displaced parallel to the road during running of the vehicle under normal conditions.

Resilient joints with variable radial rigidity are already well known, notably through the applicant's European Patent EP 0,956,984. The resilient joint described in that document comprises an inner cylindrical reinforcement, an outer cylindrical reinforcement concentrically surrounding the inner reinforcement and an elastomeric sleeve, which is arranged between the inner and outer reinforcements and the inner and outer peripheral surfaces of which are linked without any possibility of sliding on said inner and outer reinforcements. The elastomeric sleeve contains at least one socket and preferably two diametrically opposite sockets, which are positioned so that the joint presents a minimal radial rigidity along the first axis of reference mentioned above.

In service, one of the reinforcements of the resilient joint, the outer reinforcement, for example, is rigidly attached to a support part integral with the vehicle body, while the other reinforcement, the inner reinforcement, for example, is rigidly attached to the suspension arm. Attachment of the outer reinforcement to the support part is usually carried out by an operation of forced coupling or fitting of the outer reinforcement in a bore of the support part.

That method of coupling attachment is relatively complicated. In fact, it involves a control of the coupling stress and, prior to the coupling operation proper, treatments of the outer reinforcement and/or of the bore of the support part. Those treatments can consist, for example, of a lubricating operation to facilitate insertion of the outer reinforcement in the bore of the support part and/or operations of calibration of the outer peripheral surface of the outer reinforcement or of the inner surface of the bore of the support part. Those calibration operations may be necessary in order to eliminate any surface defect, for example, a possible ovalization of the outer reinforcement and/or of the bore of the support part, and so ensure a uniform contact and, therefore, a uniform tightening or binding of the outer reinforcement in the bore of the support part over the whole circumference and over the whole length of the coupling.

Considering that the support part holds the outer reinforcement by tightening or binding, it must therefore be capable of withstanding the binding stresses in service. This implies that the wall (fabric) of the support part, which surrounds the outer reinforcement of the resilient joint, is very thick.

In addition, in case the elastomeric sleeve of the resilient joint does not have an axisymmetrical shape, as is the case, for example, of a resilient joint with variable radial rigidity, as described in the aforesaid European patent application, in which the resilient joint has a minimal radial rigidity along a reference axis, it is necessary for the outer reinforcement of the resilient joint to be introduced in the bore of the support part with a precise orientation or azimuth, so that, in service, after attachment of the support part to the body of a vehicle, the reference axis along which the resilient joint presents its minimal radial rigidity will be correctly oriented in relation to a reference axis system linked to the vehicle body. With the above-mentioned method for forced coupling or fitting, if the outer reinforcement has not been introduced in the bore of the support part with the precise orientation required, it is very difficult, and even impossible, to then rectify the orientation or azimuth of the outer reinforcement in the bore of the support part.

In addition, it is necessary to guarantee a certain degree of tightening between the outer reinforcement of the resilient joint and the support part. In fact, it is necessary to ensure such level of binding pressure that, in service, the assembly coupled between the outer reinforcement and the support part presents a good resistance to the sliding of those two elements into each other axially as well as circumferentially, with a certain factor of safety relative to a maximal axial stress and/or a maximal torque sustained by the resilient joint for a maximum shock stress. That demands an appropriate choice of materials constituting the outer reinforcement and possibly treatments of those elements, in order to obtain a friction appropriate for the desired sliding resistance. In that regard, it will be noted that, to facilitate coupling of the outer reinforcement of the resilient joint in the bore of the support part, it is important for the friction between those two parts to be as weak as possible. On the other hand, to ensure the desired sliding resistance, with the desired factor of safety, it is important for the friction to be as great as possible. Those two requirements are therefore totally conflicting, so that its is difficult to satisfy both at the same time.

The present invention is therefore aimed at remedying the above-mentioned problems raised by the resilient joints previously known, in which the outer reinforcement of the flexible resilient joint is forcibly coupled in the bore of a support part.

The present invention is also aimed at providing a resilient joint with variable radial rigidity, presenting an improved fatigue strength under compressive/ tensile stresses as well as under torsional stresses.

### SUMMARY OF THE INVENTION

The present invention provides a resilient joint intended to connect a suspension arm to a vehicle body and capable of carrying a substantial part of the weight of the body, comprising an inner reinforcement, an outer reinforcement surrounding the inner reinforcement and an elastomeric sleeve, which is arranged between the inner and outer reinforcements and the inner and outer peripheral surfaces of which are linked without any possibility of sliding on said inner and outer reinforcement. An object of the invention is attained because of the fact that the outer reinforcement is so shaped that it can be directly attached to on the body of a vehicle.

The expression “directly attached” is understood here to mean that the outer reinforcement is attached to the body of the vehicle without an intermediate rigid support part, but it should not be ruled out that one or more blocks of rubber or other similar material can be inserted between the outer reinforcement and the body.

Thus, in the resilient joint according to the invention, said outer reinforcement serves both as an outer reinforcement of a known resilient joint and as support part in which the outer reinforcement of the known resilient joint previously had to be forcibly coupled in order to then make attachment of the resilient joint to the vehicle body possible.

Consequently, thanks to the present invention, it is possible to eliminate completely the coupling operation which was necessary with the known resilient joint, resulting in an industrial cost saving in assembly of the vehicle suspension elements (saving in production time and saving in production equipment, since the coupling item can be eliminated).

The invention also makes it possible to economize on material and to obtain a weight reduction. In fact, in one embodiment of the invention the outer reinforcement of the flexible joint can consist of a part cast or extruded in the form of a longitudinal member containing a housing, in which the elastomeric sleeve is formed by molding and adhered directly to the surface of the housing. With such an embodiment, compared to a known resilient joint in which the outer reinforcement is forcibly coupled in the bore of a longitudinal member, not only does the invention make it possible to eliminate a weight of material corresponding to that of the outer reinforcement of the known resilient joint, but, in addition, the part (fabric) of the longitudinal member surrounding the elastomeric sleeve can have less of a wall thickness than that of the longitudinal member associated with the known resilient joint. In fact, owing to the absence of tight coupling, it is sufficient for the fabric of the longitudinal member to be dimensioned relative to the resistance to molding injection pressures and no longer relative to the resistance to binding stresses which lead to sizable thicknesses of fabric. Of course, the fabric thickness also has to be dimensioned to tolerate the working stresses.

This invention is applicable to a resilient joint having a constant radial rigidity as well as to a resilient joint having a variable rigidity, particularly a minimal rigidity in a radial direction which, after attachment of the resilient joint to the body of a vehicle, must have a desired orientation relative to a reference axis system linked to the body of the vehicle. In the second case, the azimuth necessary to orient the minimal radial thickness of the elastomeric sleeve relative to the longitudinal member constituting the outer reinforcement and, therefore, relative to the vehicle body can be achieved easily and directly by an appropriate positioning of the cavity of the injection mold relative to the longitudinal member, in the housing of which the elastomeric sleeve is molded. For example, marks, notches, slots or other indexing means cooperating with each other can be provided on the longitudinal member and on the two cavities of the mold intended to be placed at the ends of the housing of the longitudinal member in order to ensure a correct positioning of the two mold cavities relative to the longitudinal member.

In addition, owing to the absence of a coupling link in the resilient joint according to the invention, the calibrating and/or lubricating treatment operations, which were necessary with the known resilient joints, are eliminated. In particular, the surface of the housing of the longitudinal member no longer requires specific preparation for a coupling. Furthermore, the problems of sliding resistance in the axial direction as well as circumferentially, which arise with the known resilient joints containing a coupling link between the outer reinforcement and the longitudinal member, are also completely eliminated.

In the resilient joint according to the invention, the resistance to axial and/or torsional stresses to which the joint is subjected in service is managed by the interface glued between the elastomeric sleeve and the longitudinal member. The link glued between the elastomeric sleeve and the longitudinal member is secured by glues whose shear and tear strength introduces a sufficient margin of safety in relation to the maximal values of stresses experienced in operation by the joint at the outer diameter of the elastomeric sleeve. The glues used for that purpose can be the same as those ordinarily used in the known resilient joint to link the elastomeric sleeve to the outer reinforcement and to the inner reinforcement of the joint.

The elastomeric sleeve can contain in a manner known per se, in at least one of its end faces, at least one recess which is so positioned that the joint has a minimal radial rigidity along a first reference axis of a system of three reference axes, a second reference axis of which is merged with the axis of rotation of the resilient joint. In that case, the second object of the invention is attained because of the fact that at least one of the two end faces of the sleeve has a profile which evolves continuously in the circumferential direction of the elastomeric sleeve between at least one low point and one high point.

The two end faces of the sleeve preferably have a wavy profile.

The profile preferably has an appreciably sinusoidal or pseudosinusoidal shape.

The profile in the inner peripheral region of said end face preferably has at least one low point and at least one high point, which are offset by a predefined angle relative to at least one low point and at least one high point of the profile in the outer peripheral region of said end face, when no load is applied to the joint.

In that case, said predefined angle is preferably so chosen that, when the joint is subjected to a reference load producing a relative rotation of said predefined angle of the inner and outer reinforcements relative to one another, the geometric loci of the low points and the geometric loci of the high points of the profile between said inner and outer peripheral regions are oriented appreciably radially along the first reference axis and along a third reference axis of the three reference axis system respectively.

The longitudinal member forming the outer reinforcement preferably contains at least one bearing face and preferably two bearing faces, capable of cooperating with at least one corresponding bearing face on the vehicle body, so that, after attachment of the longitudinal member to said body, the three reference axes of the resilient joint have predefined orientations relative to a reference axis system linked to the vehicle body.

The first reference axis is preferably appreciably perpendicular to a horizontal plane linked to the vehicle body.

### BRIEF DESCRIPTION OF THE DRAWINGS

Other characteristics and advantages of the invention will appear in the following description of an embodiment given by way of example with reference to the attached drawings, in which:

FIG. 1 very schematically represents a vehicle axle incorporating two resilient joints according to the invention;

FIG. 2 is a view in perspective of one of the two resilient joints incorporated in the axle of FIG. 1;

FIG. 3 is a horizontal cutaway view of the resilient joint of FIG. 2;

FIG. 4 is a view in elevation, in free state, of the elastomeric sleeve of the resilient joint of FIGS. 2 and 3;

FIG. 5 is a view of the elastomeric sleeve along arrow F of FIG. 4;

FIG. 6 is a view similar to FIG. 4 and shows the shape of the elastomeric sleeve when it is subjected to a torsional reference load;

FIG. 7 is a view similar to FIG. 5, the elastomeric sleeve being subjected to a torsional reference load;

FIG. 8 is a cutaway view following the dotted line VIII-VIII of FIG. 7;

FIG. 9 is a graph showing the wavy profile of one of the end faces of the elastomeric sleeve in the inner peripheral region and in the outer peripheral region of said sleeve, when the latter is in free state; and

FIG. 10 is a graph showing the wavy profile of the end face of the elastomeric sleeve in the inner peripheral region and in the outer peripheral region of said sleeve, when it is subjected to a torsional reference load.

### DETAILED DESCRIPTION OF THE INVENTION

Referring to FIG. 1, an axle 1 can be seen, more specifically a rear axle, intended to be mounted on the body 2 of a vehicle by means of resilient joints 3, an advantageous embodiment of which will be described in detail presently. In FIG. 1, a system of three reference axes X, Y and Z linked to the vehicle body is also represented. Axis X is the longitudinal median axis of the vehicle, axis Y is a transverse axis defining with axis X the horizontal reference plane mentioned above, and axis Z is vertical.

The axle 1 essentially contains two drawn suspension arms 4 which are connected to the body 2 by resilient joints 3 capable of working on compression/ traction and on torsion, so that the two suspension arms 4 can have, independent of each other, an angular clearance limited in relation to the body 2 around the axis 6 of the joints 3, which is merged with axis Y.

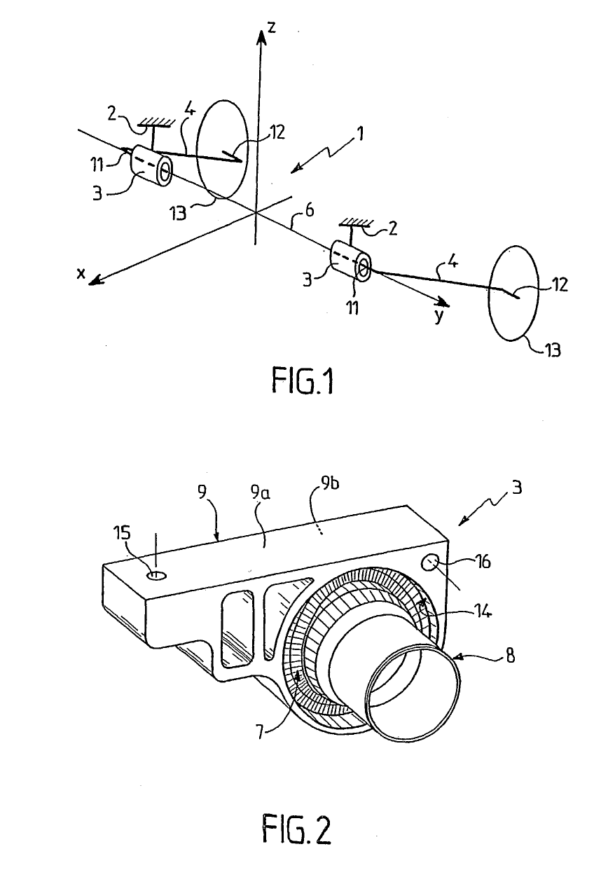

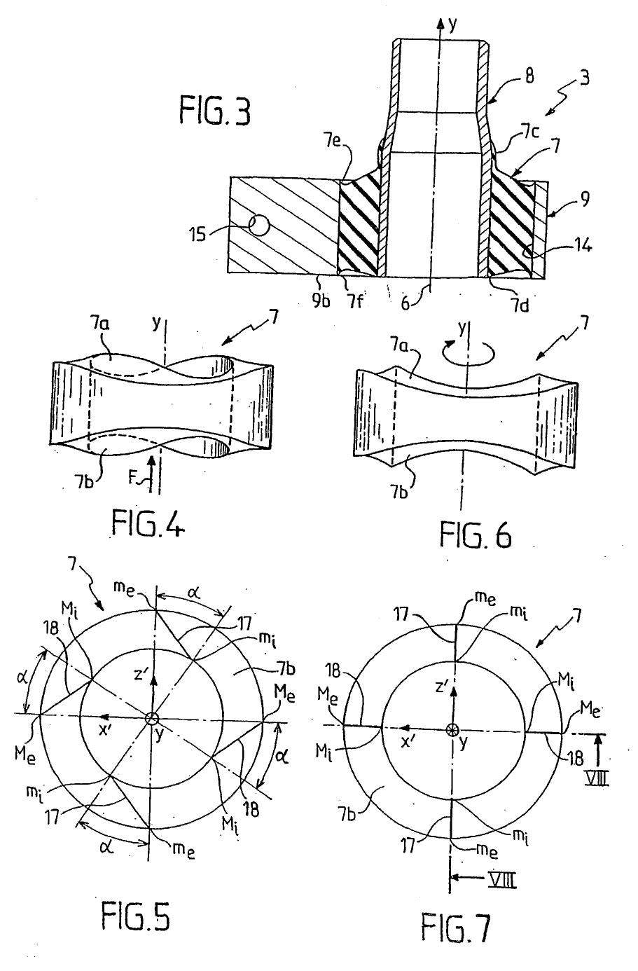

FIGS. 2 and 3 represent one of the two joints 3, which are similar (symmetrical, in general). As shown in FIGS. 2 and 3, joint 3 essentially consists of an elastomeric sleeve 7, which is arranged between an inner cylindrical reinforcement 8 and an outer reinforcement 9 and which is rigidly attached to those two reinforcements, without any possibility of sliding, by the known adherence method.

Returning to FIG. 1, it can be seen that each suspension arm 4 bears, beside the corresponding resilient joint 3, a shaft 11 and, on the side opposite said joint, a stub axle 12 intended to receive a wheel 13, more precisely a rear wheel of the vehicle. Each of the two shafts 11, whose axes are aligned with the axis 6 of the resilient joints 3 and with axis Y, is rigidly attached, that is, without any possible relative rotation, to the inner reinforcement 8 of the corresponding resilient joint. For example, the shaft 11 can be attached to the inner reinforcement 8 by forcibly fitting, by gluing or by any other method known in this field of the art. In addition, a cross member (not shown) can be provided, which connects the two shafts 11 in a U-configuration, or the two arms 4 in an H-configuration. The cross member can have a structure similar to that described in European Patent EP 0,956,984 or in published patent application WO 97/47486.

Referring again to FIGS. 2 and 3, it can be seen that the outer reinforcement 9 of the resilient joint 3 consists here of a longitudinal member, made, for example, in the form of a part cast or molded in aluminum or aluminum alloy. The longitudinal member 9 presents a housing 14 in which the elastomeric sleeve 7 of the resilient joint 3 is rigidly attached.

The longitudinal member (support surface or rail) 9 contains at least one flat bearing face and preferably two flat bearing faces 9a and 9b, which are perpendicular to each other and are intended to serve as reference surface for mounting the longitudinal member 9 on the body 2 of the vehicle. Flat face 9b is perpendicular to the axis of the housing 14 and, therefore, also to axis Y of the resilient joint 3, and is intended to be applied against a vertical bearing surface of the body 2, which is parallel to the plane defined by axes X and Z of the reference system linked to the vehicle body. Flat bearing face 9a of the longitudinal member 9 is intended to be applied against another flat bearing surface which is provided on the body 2 of the vehicle and is parallel to the horizontal plane defined by both axes X and Y of the reference system linked to the body of the vehicle.

The longitudinal member 9 further contains two holes 15 and 16, the axes of which are perpendicular to flat bearing faces 9a and 9b respectively. The holes 15 and 16 are intended to receive screws or bolts (not shown) and constitute, in combination with said screws or bolts, anchoring means for the attachment of the longitudinal member 9 on the aforesaid bearing surfaces of the vehicle body.

Each of the resilient joints 3 is preferably designed to present a variable radial rigidity circumferentially; that is, the rigidity of the joint varies with the polar angle of the radial direction around axis Y.

For that purpose, the sleeve 7 can have any known structure or geometry suitable for providing it with a variable radial rigidity. For example, the sleeve 7 can contain sockets like those of the elastomeric sleeve of the resilient joint described in European Patent EP 0,956,984.

However, according to the present invention, the variation of radial rigidity is preferably obtained by giving at least one of the two end faces 7a and 7b of the elastomeric sleeve 7 and preferably both its end faces a profile which continuously evolves in the circumferential direction of the sleeve 7 between at least one low point and at least one high point, as can be seen, notably, in FIG. 4. The wavy profile has, for example, a sinusoidal or pseudosinusoidal shape with two low points and two high points on the circumference of the sleeve 7.

Considering that the resilient joint is intended to work not only on compression/traction, but also on torsion, in order to carry a substantial part of the weight of the body and to ensure a suspension spring function, it is preferable for the two low points mᵢ and the two high points Mᵢ of the wavy profile Pᵢ in the inner peripheral region of the end face 7a or 7b to be angularly offset by a predefined angle α relative to the two low points mₑ and to the two high points Mₑ of the wavy profile Pₑ respectively in the outer peripheral region of the end face 7a or 7b, when the sleeve 7 is not subjected to any load, as shown in FIGS. 5 and 9. Between the low points mᵢ and mₑ, the geometric loci 17 of the low points of the wavy profile of the end face 7a or 7b of the sleeve 7 extend obliquely relative to a radial direction, as shown in FIG. 5. Likewise, between the high points Mᵢ and Mₑ, the geometric loci 18 of the high points of the wavy profile of the end face 7a or 7b extend obliquely relative to another radial direction, as is also shown in FIG. 5.

The value of the predefined angle α is so chosen that, when the resilient joint 3 is subjected to a reference load producing a relative rotation of that angle α, for example, of the inner reinforcement 8 relative to the outer reinforcement 9 (longitudinal member), the sleeve 7 undergoes a torsion and is so deformed that the low points mᵢ and the high points Mᵢ of the wavy profile Pᵢ in the inner peripheral region of the end face 7a or 7b are radially aligned with the respective low points mₑ and the high points Mₑ of the wavy profile Pₑ in the outer peripheral region of the end face 7a or 7b, as shown in FIGS. 7 and 10. The geometric loci 17 of the low points and the geometric loci 18 of the high points of the wavy profile on each of the two end faces 7a and 7b of the sleeve 7 are then respectively oriented appreciably radially along the two reference axes X′ and Z′ of a system of three reference axes X′, Y, Z′ linked to each resilient joint 3. Both axes X′ and Z′ are perpendicular to axis Y of the two resilient joints 3, which is also designated by reference 6 in FIG. 1.

The above-mentioned reference load, which determines the value of angle α as well as a reference position of the vehicle containing the axle 1 of FIG. 1, equipped with the two resilient joints 3 according to the invention, can be defined, for example, as being the load applied to each of the two wheels 13 of the axle 1 for a vehicle in working order and in current use. That reference load is, of course, going to vary from one vehicle model to another and its definition can in turn vary from one vehicle manufacturer to another. For example, for a four-wheeled vehicle, the reference load can be defined as being one-quarter of the sum of the empty weight of the vehicle, of the weight of two mannequins of 75 kg each and of a fuel weight corresponding to a half-full fuel tank.

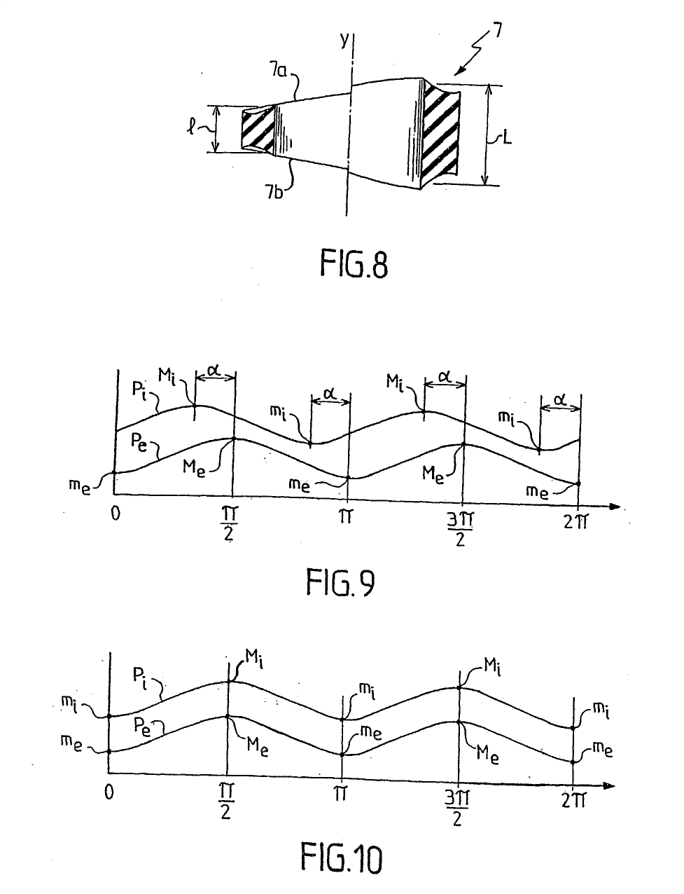

With the construction of the resilient joint 3 described above, the axial length of the elastomeric sleeve 7 has a minimal value corresponding to the geometric loci 17 of the low points of the wavy profile of the two end faces 7a and 7b, that is, in the plane defined by the two axes Y and Z′, and a maximal value L corresponding to the geometric loci 18 of the high points of the wavy profile of the two end faces 7a and 7b, that is, in the plane defined by the two axes Y and X′, as shown respectively in the left and right halves of FIG. 8. Considering that the radial rigidity of an elastomeric sleeve is, on first approximation, proportional to the axial length of the sleeve, the resilient joint 3 described above will therefore have a minimal radial rigidity along axis Z′ and a maximal radial rigidity along axis X′, when the sleeve is subjected to the reference load.

On mounting of the two resilient joints 3 on the body 2, axes X′ and Z′ of each joint 3 are oriented, thanks to the above-mentioned bearing surfaces 9a and 9b of the longitudinal members 9 and of the body 2, so as to be respectively parallel to axes X and Z of the system of axes X, Y, Z linked to the body 2 of the vehicle. That is, axis X′ is horizontal and axis Z′ is vertical. It is in that position that the sound-filtering performances of the two resilient joints 3 prove best. However, it is not absolutely indispensable for axis Z′ of each joint 3 to be oriented strictly vertically and its orientation may range between the limits of +45° and −45° relative to a line perpendicular to the horizontal plane defined by axes X and Y of the reference system linked to the body of the vehicle. Likewise, neither is it absolutely indispensable for the low points and high points of the wavy profile of each of the end faces 7a and 7b of the sleeve 7 to be angularly equidistant along the circumference.

For example, when axes X′ and Z′ of the joints 3 are respectively oriented along axes X and Z of the vehicle, the maximum radial rigidity (longitudinal rigidity along X) of each joint 3 can be approximately 3,500 N/mm and the minimal radial rigidity (vertical rigidity along Z) approximately 2,200 N/mm.

The resilient joint 3 with variable radial rigidity according to the invention has, compared to the resilient joints with variable radial rigidity previously known, a better fatigue resistance when the joint works on compression/traction as well as when it works on torsion. One might think that is due to the continuous and regular evolution of the wavy profile of its two end faces 7a and 7b, which, in service, cause the compressive/tensile stresses and the torsional stresses not to stay concentrated in the localized zones of the sleeve 7, but they can be distributed more easily in the core of said sleeve over its whole circumference.

It goes without saying that the embodiment of the invention described above has been given purely by way of example that is indicative and not at all limitative, and that numerous modifications can be introduced by the expert without departing from the scope of the invention. Thus, notably, although the elastomeric sleeve 7 has been represented with a longitudinal section that is appreciably trapezoid-shaped, in which the wide base is situated on the side of the inner reinforcement 8 and the narrow base is on the side of the outer reinforcement 9, and with inner peripheral lips 7c and 7d and outer peripheral lips 7e and 7f on the end faces 7a and 7b, as shown, notably, in FIG. 2, the longitudinal section of the sleeve 7 could, for example, have a rectangular shape.

In addition, the number of low points and the number of high points of the profile along the circumference of the end face or of each of the end faces of the elastomeric sleeve is not necessarily equal to two. That number can be equal to one or more than two, depending on the number of radial directions along which it is desirable for the elastomeric sleeve to have a minimal radial rigidity and a maximal radial rigidity respectively.

Furthermore, although in the representation of FIGS. 9 and 10 the peak-to-peak amplitude of the undulation (difference in amplitude between the low points and the high points) of the profile Pᵢ in the inner peripheral region of an end face 7a or 7b of the sleeve 7 is equal or roughly equal to the peak-to-peak amplitude of the undulation of the profile Pₑ in the outer peripheral region of said end face 7a or 7b, the two profiles Pᵢ and Pₑ can have different peak-to-peak amplitudes and, in an extreme case, one of the two profiles Pᵢ and Pₑ can have a nil or almost nil peak-to-peak amplitude.

In addition, in order to obtain a variable radial rigidity, the profile of the end face or faces of the sleeve, which evolves continuously in the circumferential direction of the sleeve, can be combined with a continuous variation of the radial thickness of said sleeve along the circumference of the latter, so that the cross section of the housing 14 of the longitudinal member 9 and/or the cross section of the reinforcement 8 are not necessarily circular, but can, for example, have an elliptical or oval shape or a shape presenting one or more flat surfaces. Such noncircular shapes might also be rendered necessary for various other reasons, like, for example, the type of link between reinforcement 8 and arm 4. However, the circular or cylindrical configuration of the housing 14 and of the inner reinforcement 8 remains most favorable in terms of fatigue, for the stresses prevailing on service in the sleeve 7 are most homogeneous there.

Finally, the connection of the outer reinforcement or longitudinal member 9 to the body 2 by two bearing surfaces and two perpendicular screws represents only one case of totally special mounting. More generally speaking, the longitudinal member can be anchored or fixed on the body in different ways. The screw connection is one possibility (in that case, the minimum is one screw and, therefore, one through hole per joint). Welding or gluing can also be mentioned as other attachment possibilities.

We claim:

1. A resilient joint intended to connect a suspension arm to a vehicle body and capable of working on torsion and of carrying a substantial part of the weight of the body, comprising an inner reinforcement, an outer reinforcement surrounding the inner reinforcement and an elastomeric sleeve, which is arranged between the inner and outer reinforcements and the inner and outer peripheral surfaces of which are linked without any possibility of sliding on said inner and outer reinforcements, characterized in that the outer reinforcement is so shaped that it can be directly attached to on the body of a vehicle.

2. The resilient joint according to claim 1, wherein the outer reinforcement consists of a part cast or extruded in the form of a longitudinal member containing a housing, in which the elastomeric sleeve is formed by molding and adhered directly to the surface of the housing.

3. The resilient joint according to claim 2, wherein said sleeve contains, in at least one of its end faces, at least one recess which is so positioned that the joint has a minimal radial rigidity along a first reference axis Z′ of a system of three reference axes X′, Y, Z′, a second reference axis Y of which is merged with the axis of rotation of the resilient joint.

4. The resilient joint according to claim 3, wherein at least one of the two end faces of the sleeve has a profile which evolves continuously in the circumferential direction of the elastomeric sleeve between at least one low point and one high point.

5. The resilient joint according to claim 4, wherein the two end faces of the sleeve have a wavy profile.

6. The resilient joint according to claim 5, wherein the profile has an appreciably sinusoidal or pseudosinusoidal shape.

7. The resilient joint according to claim 6, wherein the profile Pᵢ in the inner peripheral region of said end face preferably has at least one low point mᵢ and at least one high point Mᵢ, which are offset by a predefined angle α relative to at least one low point mₑ and at least one high point Mₑ of the profile Pₑ in the outer peripheral region of said end face, when no load is applied to the joint.

8. The resilient joint according to claim 7, wherein said predefined angle α is preferably so chosen that, when the joint is subjected to a reference load producing a relative rotation of said predefined angle of the inner reinforcement and outer reinforcement relative to one another, the geometric loci of the low points and the geometric loci of the high points of the profile between said inner and outer peripheral regions are oriented appreciably radially along the first reference axis Z′ and along a third reference axis X′ of the three reference axis system respectively.

9. The resilient joint according to claim 8, wherein the longitudinal member contains at least one bearing face and preferably two bearing faces, capable of cooperating with at least one corresponding bearing face on the vehicle body 2, so that, after attachment of the longitudinal member to said body, the three reference axes X′, Y, Z′ of the resilient joint have predefined orientations relative to a system of reference axes X, Y, Z linked to the vehicle body.

10. The resilient joint according to claim 9, wherein the first reference axis Z′ is appreciably perpendicular to a horizontal plane linked to the vehicle body.

11. A vehicle suspension containing two resilient bearing joints working on torsion, characterized in that each resilient joint is a joint according to any one of claims 1, 2, 3, 4, 5, 6, 7, 8, 9 or 10.
